(19) United States
(12) Patent Application Publication
(10) Pub. No.: US 2016/0379167 A1
(43) Pub. Date: Dec. 29, 2016

(54) DYNAMIC RESOURCE ALLOCATION AND SCHEDULING

(71) Applicant: Amazon Technologies, Inc., Seattle, WA (US)

(72) Inventor: Amirtha Raman, Seattle, WA (US)

(21) Appl. No.: 14/750,231

(22) Filed: Jun. 25, 2015

(51) Int. Cl. G06Q 10/08; G06Q 10/10

(52) U.S. Cl. CPC G06Q 10/08355; G06Q 10/1097

(57) ABSTRACT

A dynamic resource scheduler receives a first request to schedule a first event at a first location during a first time period and a second request to schedule a second event at a second location. When the dynamic resource scheduler determines that the second location is within a threshold distance of the first location, the dynamic resource scheduler determines and presents a first plurality of selectable time period options for scheduling the second event that includes at least one of the first time period and a second, adjacent time period and schedules the second event during a selected time period.

### BACKGROUND

One scheduling technique includes first defining resource capacity and then capturing requests for resources and scheduling available resources in response to those requests based on the resource capacity. For example, an airplane has a fixed number of seats, so only a limited number of reservation requests can be accepted. When capacity is not fixed, however, resources can be allocated in response to requests on an as needed basis. For example, when selling copies of a book, as many copies as needed can be printed and shipped to requesting customers.

### BRIEF DESCRIPTION OF THE DRAWINGS

Embodiments of the present invention will be understood more fully from the detailed description given below and from the accompanying drawings, which, however, should not be taken to limit the present invention to the specific embodiments, but are for explanation and understanding only.

FIG. 1 is a diagram illustrating dynamic resource allocation and scheduling, according to an embodiment.

FIG. 2 is a block diagram illustrating a networked environment in which embodiments of the present disclosure may be implemented.

FIG. 3 is a block diagram illustrating a dynamic resource scheduler, according to an embodiment.

FIGS. 4-7 are diagrams illustrating geographic sector grids for use in the dynamic allocation and scheduling of resources, according to an embodiment.

FIG. 8 is a flow diagram illustrating a dynamic resource scheduling method, according to an embodiment.

FIG. 9 is a flow diagram illustrating a dynamic resource scheduling method, according to an embodiment.

FIG. 10 is a flow diagram illustrating a dynamic resource scheduling method, according to an embodiment.

FIG. 11 is a block diagram illustrating an exemplary computer system, according to an embodiment.

### DETAILED DESCRIPTION

When allocating and scheduling resources, such as delivery trucks used to deliver packages to or pick-up packages from customers in a given geographic area, suppliers may seek to optimize resource usage based on the current demand. As customers place orders and packages are scheduled for delivery across the geographic area, the supplier may determine how many trucks can be used to efficiently deliver the packages to the requesting customers. For example, delivery routes can be built dynamically based on the demand (i.e., the number of orders or requests for delivery) assuming that the resource capacity is not fixed (i.e., additional delivery trucks can be allocated and additional delivery routes can be created, as needed). In this case the resources are only allocated based on the demand and are not scheduled unnecessarily.

Certain suppliers allow customers to request a specific time period or scheduling window for delivery of a package. For example, the supplier may provide the user with options of 9-10 am, 10-11 am or 11 am-12 pm, during which the package will be delivered. Based on the user selection of one of the time periods, the supplier may allocate delivery trucks for scheduled deliveries in order to meet all of the customer requests. If, however, multiple customers who are not in close geographic proximity request the same time period for delivery, this results in fragmented resource allocation and the supplier will have to allocate multiple delivery trucks. Similarly, if customers who are in close geographic proximity request delivery windows that are widely varied, a single delivery truck may have to spend time waiting (i.e., downtime) at the given location in order to make the deliveries during the requested time period.

In one embodiment, a dynamic resource scheduler manages the allocation and scheduling of resources in order to optimize the efficiency of delivery routes and reduce the number of delivery vehicles utilized, thereby reducing overall costs in time, money and resources. In one embodiment, the dynamic resource scheduler builds delivery routes, or other sequences of events, by utilizing the location and time periods of previously scheduled events (e.g., package deliveries). For example, if a request for a new delivery at a certain location is received, the dynamic resource scheduler may identify any previously scheduled deliveries at locations in relative close proximity (e.g., within a threshold distance). If current resources are available (e.g., if the delivery truck assigned to that route has time to make additional deliveries), the dynamic resource scheduler may offer delivery time period options for the new delivery that are the same as or adjacent to the time periods of the previously scheduled deliveries in the same geographic area. Thus, if a delivery is already scheduled for the 9-10 am window at a certain location and a new delivery is requested nearby that location, the dynamic resource scheduler may offer selectable time period options of 9-10 am and/or 10-11 am for the new delivery. That way, the two deliveries can be made by the same delivery truck, without unnecessary downtime.

Conversely, if the new delivery request is for a location that is not near any previously scheduled delivery locations, the dynamic resource scheduler may offer selectable time period options without restrictions as to when other deliveries are scheduled. This may allow the same delivery truck to make all of the scheduled deliveries on time. In one embodiment, the dynamic resource scheduler may add the new delivery to a second delivery route that will be serviced by a different delivery truck. In this case, the time period options presented to the customer may be those that can optimize the second delivery route. As new delivery requests are received, the dynamic resource scheduler may continuously perform optimization calculations to determine to which routes new delivery events may be added and the corresponding time periods for which those delivery events may be scheduled. This optimization may continue up until a designated cut-off time (e.g., 10 pm the night before the scheduled deliveries) or up until the delivery truck is scheduled to leave the supplier station to begin the delivery route.

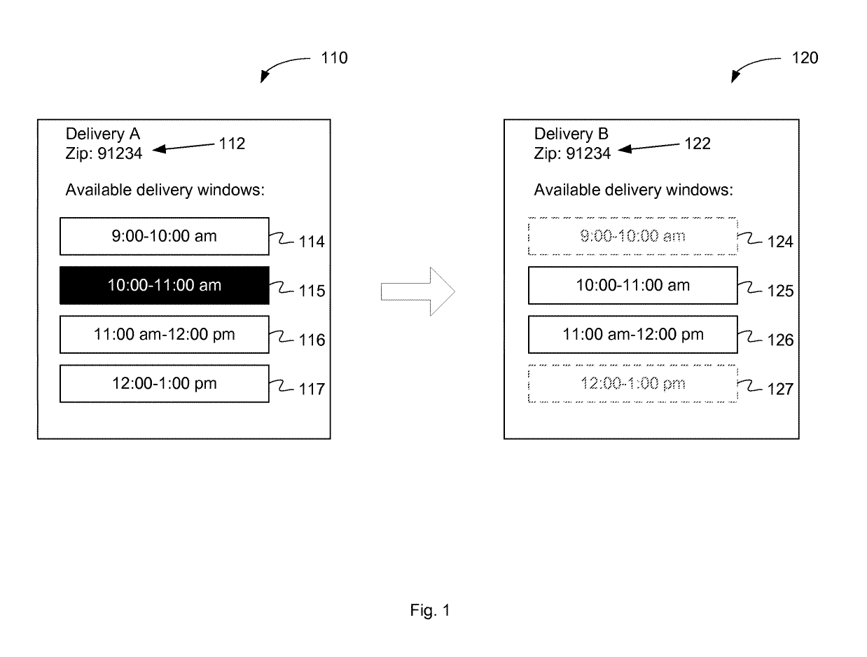

FIG. 1 is a diagram illustrating dynamic resource allocation and scheduling, according to an embodiment. Display 110 includes a user interface through which a customer can request a delivery to be made to a certain location during one of multiple available time period windows. In this embodiment, the Delivery A is to be made at a specified location 112 during one of the available delivery windows 114-117. For example, the available delivery windows 114-117 are broken down into one hour segments ranging from 9:00 am until 1:00 pm. As illustrated in display 110, delivery window 115 (i.e., 10-11 am) has been selected by the customer. Accordingly, the dynamic resource scheduler may create a delivery event on a first delivery route for the specified location 112 for the selected time period 115.

Subsequently, as shown in display 120, a request for a new Delivery B is received. In one embodiment, the Delivery B is to be made at a location 122 that is the same or similar to the location 112 of Delivery A. When the location 122 is within a specified distance threshold of the location 112, the dynamic resource scheduler may surface, present or provide a limited number of selectable delivery window options based on the selected time period 115 of the previously scheduled Delivery A. In one embodiment, only the same time period 125 (e.g., 10-11 am) or an adjacent time period 126 (e.g., 11 am-12 pm) are presented as selectable options. Other potential delivery windows 124 and 127 may be marked as unavailable (e.g., grayed out) or may not be presented at all in display 120. In one embodiment, the remaining time periods may still be provided in display 120, and may be selected by the user, however, certain delivery time periods 125 and 126 may be highlighted, emphasized, incentivized or otherwise suggested such that the user is encouraged to select one of those time periods in order to improve resource allocation. In one embodiment, a customer may select one or more of the available delivery windows 125 and 126, and may optionally provide an indication of which of selected windows is more preferred. For example, the customer may select a first choice, a second choice and a third choice. In another embodiment, the customer may select multiple windows without providing any preference information, in which case, all selected windows may be ranked equally. If the user selects only one window 125, then the dynamic resource scheduler may create a delivery event on the first delivery route for the specified location 122 for the selected time period 125. If the user selects more than one window 125 and 126 as alternative delivery time periods, then the dynamic resource scheduler may create a delivery event either on the first delivery route or a second delivery route for either of the selected time periods 125 and 126, depending on which time period will best optimize or at least improve the resource allocation and scheduling.

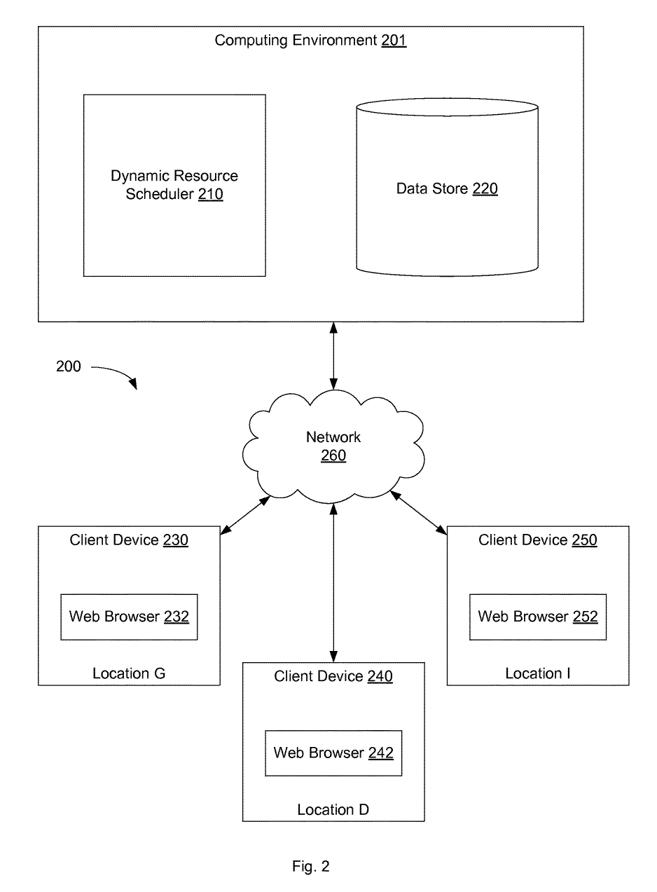

FIG. 2 is a block diagram illustrating a networked environment for dynamic resource allocation and scheduling, according to an embodiment. The networked environment 200 includes a computing environment 201 and one or more client devices 230, 240 and 250 which are in data communication with each other via a network 260. The network 260 includes, for example, the Internet, intranets, extranets, wide area networks (WANs), local area networks (LANs), wired networks, wireless networks, or other suitable networks, etc., or any combination of two or more such networks. For example, such networks may comprise satellite networks, cable networks, Ethernet networks, and other types of networks.

The computing environment 201 may include, for example, a server computer or any other system providing computing capability. Alternatively, the computing environment 201 may employ a plurality of computing devices that may be arranged, for example, in one or more server banks or computer banks or other arrangements. Such computing devices may be located in a single installation or may be distributed among many different geographical locations. For example, the computing environment 201 may include a plurality of computing devices that together may comprise a hosted computing resource, a grid computing resource and/or any other distributed computing arrangement. In some cases, the computing environment 201 may correspond to an elastic computing resource where the allotted capacity of processing, network, storage, or other computing-related resources may vary over time.

Various applications and/or other functionality may be executed in the computing environment 201 according to various implementations. Also, various data may be stored in a data store 220 that is accessible to the computing environment 201. The data store 220 may be representative of a plurality of data stores, as can be appreciated. The data stored in the data store 220, for example, is associated with the operation of the various applications and/or functional entities described below.

The components executed on the computing environment 201, for example, can include a dynamic resource scheduler 210, and other applications, services, processes, systems, engines, or functionality not discussed in detail herein. The dynamic resource scheduler 210 may be executed to manage the allocation and scheduling of resources in order to optimize the efficiency of a sequence of scheduled events. In one embodiment, the dynamic resource scheduler 210 builds delivery routes, or other sequences of events, by utilizing the locations and time periods of previously scheduled events (e.g., package deliveries) and offering selectable delivery time period options for future deliveries that are the same as or adjacent to the time periods of the previously scheduled deliveries in the same geographic area. Additional details of dynamic resource scheduler 210 are provided below.

Client devices 230, 240 and 250 are representative of a plurality of client devices that may be coupled to the network 260. The client devices 230, 240 and 250 may each comprise, for example, a processor-based system such as a computer system. Such a computer system may be embodied in the form of a desktop computer, a laptop computer, a personal digital assistant, cellular telephone, smartphone, set-top box, music player, web pad, tablet computer system, game console, electronic book reader, or other device with similar capability. In one embodiment, the client devices 230, 240 and 250 may each be located at a different geographic location. In one embodiment, however, certain devices may be located in relative close proximity to one another as compared to one or more other of the client devices 230, 240 and 250. In one embodiment, the client devices 230, 240 and 250 may each include a web browser 232, 242 and 252 or some other application or communication program. Web browsers 232, 242 and 252 may be utilized to access a web page provided by a supplier, over network 260, through which events may be scheduled. For example, web browsers 232, 242 and 252 may be used to place orders and schedule deliveries of packages at a specified location and during a requested time period or delivery window. Requests sent using web browsers 232, 242 and 252 may be received and processed by dynamic resource scheduler 210, as will be described in more detail below. In another embodiment, requests for deliveries or to schedule some other events may be made through a stand-alone application running on one of client devices 230, 240, 250 rather than through a web browser.

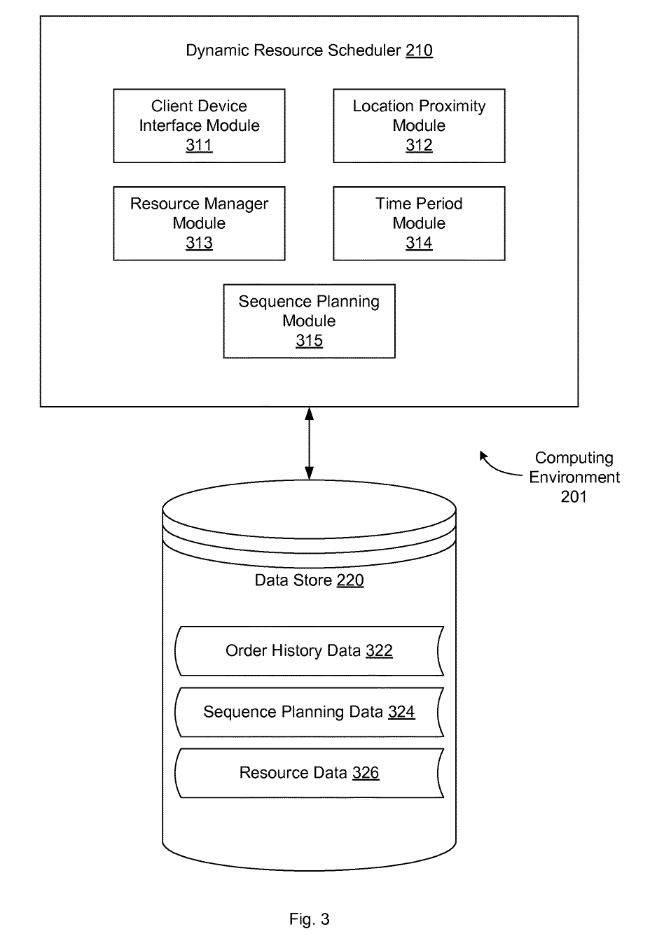

FIG. 3 is a block diagram illustrating a dynamic resource scheduler 210 that is included in computing environment 201, according to an embodiment. In one embodiment, dynamic resource scheduler 210 includes client device interface module 311, location proximity module 312, resource manager module 313, time period module 314 and sequence planning module 315. This arrangement of modules and components may be a logical separation, and in other embodiments, these modules or other components can be combined together or separated in further components, according to a particular embodiment. In one embodiment, data store 220 is connected to dynamic resource scheduler 210 and includes order history data 322, sequence planning data 324, and resource data 326. In one embodiment, computing environment 201 may include both dynamic resource scheduler 210 and data store 220. In another embodiment, data store 220 may be external to computing environment 201 and may be connected to computing environment 201 over a network or other connection. In other embodiments, dynamic resource scheduler 210 may include different and/or additional components which are not shown to simplify the description. Data store 220 may include one or more mass storage devices which can include, for example, flash memory, magnetic or optical disks, or tape drives; read-only memory (ROM); random-access memory (RAM); erasable programmable memory (e.g., EPROM and EEPROM); flash memory; or any other type of storage medium.

In one embodiment, client device interface module 311 is responsible for communication and interaction with web browsers 232, 242 and 252 on client devices 230, 240 and 250. In one embodiment, client device interface module 311 receives information sent from web browsers 232, 242, 252, such as a request to schedule an event at a specified location. For example, client device interface module 311 may receive a request for delivery or pick-up of a package at a certain address. After determination by dynamic resource scheduler 210, client device interface module 311 may generate and present a user interface (e.g., display 110 or 120, as shown in FIG. 1) with a set of selectable time period options during which the event may be scheduled. Client device interface module 311 may receive a customer selection of one or more of the presented time period options and notify other modules in dynamic resource scheduler 210 of the selection.

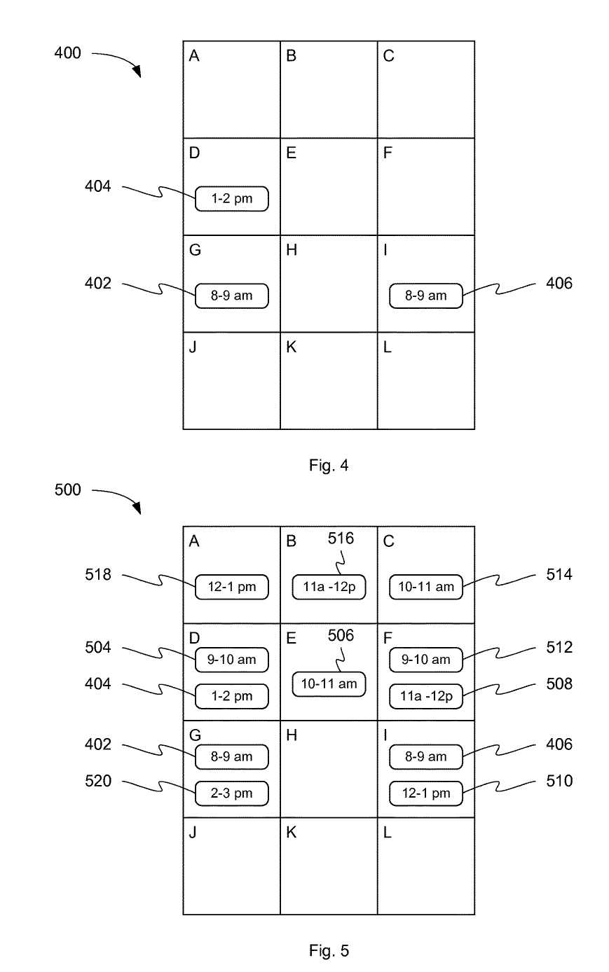

In one embodiment, location proximity module 312 determines the relative locations of already scheduled events and events to be scheduled in the future. In one embodiment, location proximity module 312 receives location information for a new order from user input received by client device interface module 311 and consults order history data 322 in data store 220 to obtain location information of previously placed orders. Location proximity module 312 may compare a distance between the location of the new order and the locations of the previous orders to a threshold distance. The threshold distance may be measured using at least one of a Euclidian distance, network distance or a number of event sectors between two locations. Euclidean distance is the absolute distance measured between two locations in a straight line (i.e. “as the crow flies”), while the network distance is a more realistic representation of movements between locations, including the distance between locations measured along a transportation network (e.g., system of roads), usually using the shortest or quickest path. In one embodiment, a certain geographic area may be logically divided into a number of event sectors. For example, sector grid 400 shown in FIG. 4 has a certain geographic area logically divided into twelve event sectors A-L. Depending on the size of the event sectors, the threshold distance may be met for any locations that are within the same or adjoining event sectors. Thus, locations in sectors A and B would be within the threshold distance, while locations in sectors A and C would not. In other embodiments, the threshold distance may be measured in some other way or have some other value.

In one embodiment, resource manager module 313 manages the allocation and scheduling of resources associated with a sequence of events. For example, when dynamic resource scheduler 210 creates a delivery route of planned package deliveries on a given day, resource manager module 313 may allocate a delivery vehicle to service that route. Resource manager module 313 may determine the quantity of delivery vehicles needed to service the various created routes and may track the availability of each vehicle to accommodate additional delivery requests. For example, each vehicle may have a maximum number of deliveries that it can make in one day, a maximum number of deliveries it can make on one route (assuming multiple routes per day), or a maximum number of deliveries it can make during a given delivery time period or window. In one embodiment, these values may be determined in view of the travel distance between scheduled deliveries, expected traffic conditions, etc. In one embodiment, the resources being scheduled may include motorized manned vehicles, such as trucks, cars, boats, airplanes, etc., non-motorized vehicles, such as bicycles, motorized unmanned vehicles such as drones, or simply the availability of a person walking or running on foot. When a new delivery request is received, before a new delivery event is created on a given route during a given time period, resource manager module 313 may verify that the delivery vehicle is able to accommodate an additional delivery during the requested or available time periods. If not, resource manager module 313 may either signal that the requested time period is not available or may allocate an additional vehicle for a new route in order to accommodate the request. In one embodiment, resource manager module 313 maintains resource capacity information, resource type information, resource allocation information, etc. as part of resource data 326 in data store 220.

In another embodiment, separate from the delivery of packages, the resources may include web, server or other computing resources. In this embodiment, dynamic resource scheduler may schedule the utilization of these resources by requesting clients or other parties. For example, resource manager module 313 may monitor the availability of the resources and sequence planning module 315 may schedule the utilization of the resources according to the time periods determined by time period module 314.

In one embodiment, time period module 314 manages the scheduling of events in certain time periods. For example, when dynamic resource scheduler 210 creates a delivery route of planned package deliveries on a given day, time period module 314 may schedule each delivery in a corresponding time period. In one embodiment, depending on the number of delivery routes that have been created, there may be a maximum number of deliveries that can be made in each time period. This value may be determined in view of the travel distance between scheduled deliveries, the length of time period, etc. Furthermore, time period module 314 may generate a list of available time periods based on previously scheduled deliveries. For example, time period module 313 may utilize the location and time periods of previously scheduled events (e.g., package deliveries) and offer selectable delivery time period options for future deliveries that are the same as or adjacent to the time periods of the previously scheduled deliveries in the same geographic area. When a new delivery request is received, before a new delivery event is created on a given route during a given time period, time period module 314 may verify that the requested time period is the same as or adjacent to the time periods of the previously scheduled deliveries in the same geographic area. In one embodiment, time period module 314 may present the same time period as a previously scheduled delivery and either one, two or three periods following the same time period. In another embodiment, time period module 314 may alternatively or additionally include one, two or three time periods prior to the same time period. In one embodiment, the number of adjacent time periods may be determined in view of the length of the time periods. For example, if each time period is shorter in length (e.g., 30 minutes), then more adjacent time periods may be included. If, however, each time period is longer (e.g., 2 hours), then fewer or no adjacent time periods may be included.

In one embodiment, sequence planning module 315 generates and manages one or more sequences of events. For example, a sequence of events may include a route of planned deliveries on a given day. Sequence planning module 315 may schedule new events and add the events to new or existing sequences of events in response to a request received by client device interface module 311. In one embodiment, sequence planning module 315 may schedule an event in response to approval from one or more of location proximity module 312, resource manager module 313 and time period module 314. Sequence planning module 315 may store the events and sequences of events as sequence planning data 324 in data store 220.

In one embodiment, sequence planning module 315 may delay the planning of event sequences, such as delivery routes, until all, or at least multiple, requests for scheduling of an event have been received. This delayed calculation of sequences and allocation of resources can result in optimized delivery routes since all data is available. In embodiments, where multiple alternative delivery windows are associated with a given delivery, changes to the scheduled delivery window can be made without requiring notice to the customer. In one embodiment, the customers may not be informed of their delivery window until after the entire route is calculated, so as to reduce or eliminate the need to reschedule.

FIGS. 4-7 are diagrams illustrating geographic sector grids for use in the dynamic allocation and scheduling of resources. Sector grid 400 shown in FIG. 4 has a certain geographic area logically divided into twelve event sectors A-L. The locations of various scheduled events 402, 404 and 406 are plotted on the sector grid and the requested time period for each event is shown. As illustrated, event 402 is scheduled in sector G during the time period of 8-9 am, event 404 is scheduled in sector D during the time period of 1-2 pm, and event 406 is scheduled in sector I during the time period of 8-9 am. This scenario raises several possible concerns. First, events 402 and 406 are scheduled during the same time period (i.e., 8-9 am), but are not in close geographic proximity (i.e., they are in non-adjoining event sectors). This results in fragmented resource allocation and the supplier may have to allocate multiple delivery trucks to fulfill both deliveries during the scheduled time periods. Second, events 402 and 404 are in close geographic proximity (i.e., they are in adjoining event sectors), but have widely varied scheduled time periods. A single delivery truck may have to spend significant downtime at the given locations for events 402 and 404 in order to make the deliveries during the scheduled time periods. In one embodiment, a user may still be allowed to schedule a delivery during any time period, and dynamic resource scheduler may add that delivery to a different route or assign a different vehicle to make the delivery.

Sector grid 500 shown in FIG. 5 has the same twelve event sectors A-L and includes the locations of additional scheduled events 504-520 plotted on the sector grid. As illustrated, event 504 is scheduled in sector D during the time period of 9-10 am, event 506 is scheduled in sector E during the time period of 10-11 am, event 508 is scheduled in sector F during the time period of 11 am-12 pm, event 510 is scheduled in sector I during the time period of 12-1 pm, event 512 is scheduled in sector F during the time period of 9-10 am, event 514 is scheduled in sector C during the time period of 10-11 am, event 516 is scheduled in sector B during the time period of 11 am-12 pm, event 518 is scheduled in sector A during the time period of 12-1 pm, and event 520 is scheduled in sector G during the time period of 2-3 pm. In one embodiment, dynamic resource scheduler 210 may attempt to generate a number of delivery routes that can accommodate these requested deliveries.

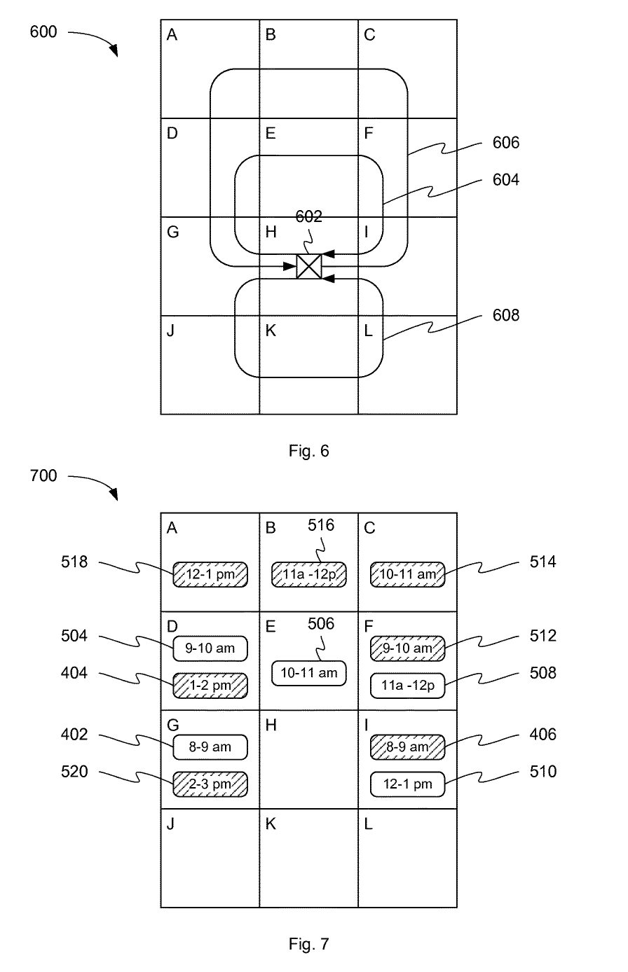

Sector grid 600 shown in FIG. 6 includes a supplier station 602 located in sector H and three scheduled delivery routes 604, 606 and 608. Supplier station 602 may be a distribution center, warehouse, office, etc. associated with the supplier of goods or a company making the package deliveries. Delivery routes 604, 606 and 608 may be dynamically generated by dynamic resource scheduler 210 in response to a number of received delivery requests, such as those illustrated in FIG. 5. The routes are dynamically determined in the sense that they are not fixed and can be updated or adjusted over time. In one embodiment, each time a new request to schedule a delivery is received, the delivery routes 604, 606 and 608 can be analyzed for optimal use of resources and recalculated if needed. In another embodiment, the routes can be recalculated periodically or in response to some other trigger. In one embodiment, dynamic resource scheduler 210 may create a delivery route and update it as each new delivery request is received. In other embodiment, dynamic resource scheduler 210 may wait until a designated cut-off time and then create the delivery routes using the previously requested deliveries.

Sector grid 700 shown in FIG. 7 indicates the locations of scheduled events, 402-406 and 504-520 with respect to event sectors A-L and supplier station 602. In FIG. 7, the event indicators are shaded according to which route they have been assigned. For example, events 402, 504, 506, 508 and 510 are not shaded and are assigned to route 604. Events 406, 512, 514, 516, 518, 404 and 520 are shaded and have been assigned to route 606. Since no events are assigned to route 608, route 608 may be deleted and the resources designated for route 608 may be reassigned or deallocated. Given the resource and time period restrictions associated with a given route (this example, assumes that a delivery vehicle can make deliveries in adjacent time event sectors within one hour of each other (e.g., in adjacent time periods)), routes 604 and 606 are sufficient to service the delivery requests illustrated in FIG. 7.

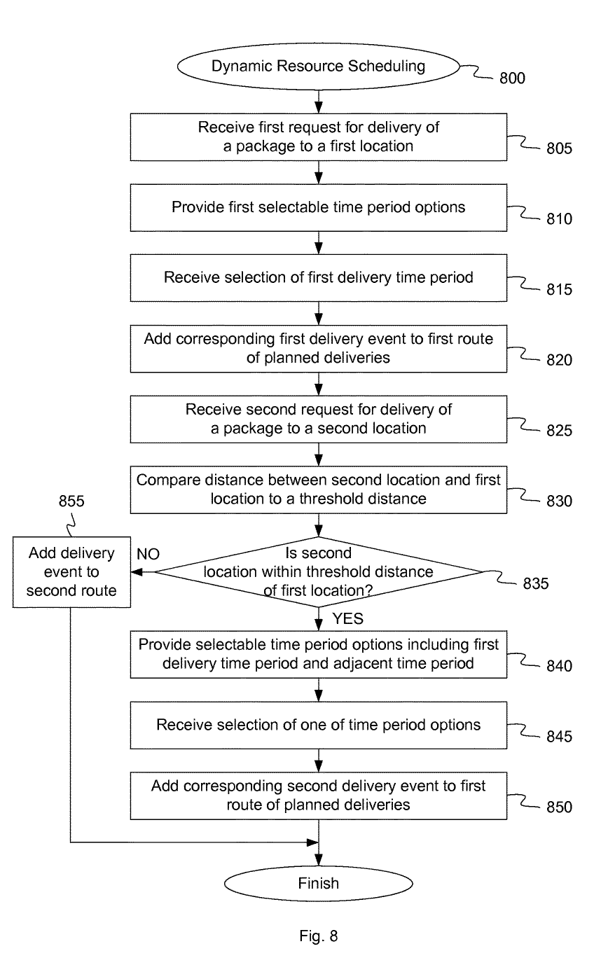

FIG. 8 is a flow diagram illustrating a dynamic resource scheduling method, according to an embodiment. The method 800 may be performed by processing logic that comprises hardware (e.g., circuitry, dedicated logic, programmable logic, microcode, etc.), software (e.g., instructions run on a processor to perform hardware simulation), firmware, or a combination thereof. The processing logic is configured to dynamically allocate and schedule resources in order to optimize a sequence of scheduled events. In one embodiment, method 800 may be performed by dynamic resource scheduler, as shown in FIGS. 2 and 3.

Referring to FIG. 8, at block 805, method 800 receives a first request for delivery of a first package to a first location. In one embodiment, client device interface module 311 receives information sent from web browsers 232, 242, 252, such as a request to schedule an event at a specified location. For example, client device interface module 311 may receive a request for delivery or pick-up of a package at a certain address.

At block 810, method 800 provides a first plurality of selectable time period options for the delivery of the first package. In one embodiment, client device interface module 311 may generate and present a user interface (e.g., display 110 as shown in FIG. 1) with a set of selectable time period options during which the event may be scheduled.

At block 815, method 800 receives a selection of a first delivery time period of the first plurality of selectable time period options. In one embodiment, client device interface module 311 may receive a customer selection of one or more of the presented time period options and notify other modules in dynamic resource scheduler 210 of the selection.

At block 820, method 800 adds a first delivery event corresponding to the first request for delivery to a first route of planned deliveries on a first day. In one embodiment, sequence planning module 315 schedules new events and add the events to new or existing sequences of events. Sequence planning module 315 may schedule an event in response to approval from one or more of location proximity module 312, resource manager module 313 and time period module 314 and store the sequences of events as sequence planning data 324 in data store 220.

At block 825, method 800 receives a second request for delivery of a second package to a second location. In one embodiment, client device interface module 311 receives the request for delivery or pick-up of a package at a different address than the first request.

At block 830, method 800 compares a distance between the second location and the first location to a threshold distance. In one embodiment, location proximity module 312 compares a distance between the second location and the first location to the threshold distance. The threshold distance may be measured using at least one of a Euclidian distance, network distance or a number of event sectors between two locations.

At block 835, method 800 determines whether the second location is within the threshold distance of the first location. If the second location is within the threshold distance of the first location, at block 840, method 800 provides a second plurality of selectable time period options for the delivery of the second package, wherein the second plurality of selectable time period options comprises at least one of the first delivery time period and a second delivery time period adjacent to the first delivery time period. In one embodiment, client device interface module 311 may generate and present a user interface (e.g., display 120 as shown in FIG. 1) with a set of selectable time period options during which the event may be scheduled. In one embodiment, the second plurality of selectable time period options includes only the first delivery time period and the adjacent delivery time period. In another embodiment, however, the second plurality of selectable time period options includes any number of additional time period options, any of which may be selected, however, the first and second delivery time periods may be highlighted, emphasized or otherwise suggested such that the user is encouraged to select one of those time periods.

At block 845, method 800 receives a selection of one or more of the second plurality of selectable time period options. In one embodiment, client device interface module 311 may receive a customer selection of one or more of the presented time period options and notify other modules in dynamic resource scheduler 210 of the selection. At block 850, method 800 adds a second delivery event corresponding to the second request for delivery to the first route.

If the second location is not within the threshold distance of the first location, at block 855, method 800 adds the second delivery event corresponding to the second request for delivery to a second route of planned deliveries.

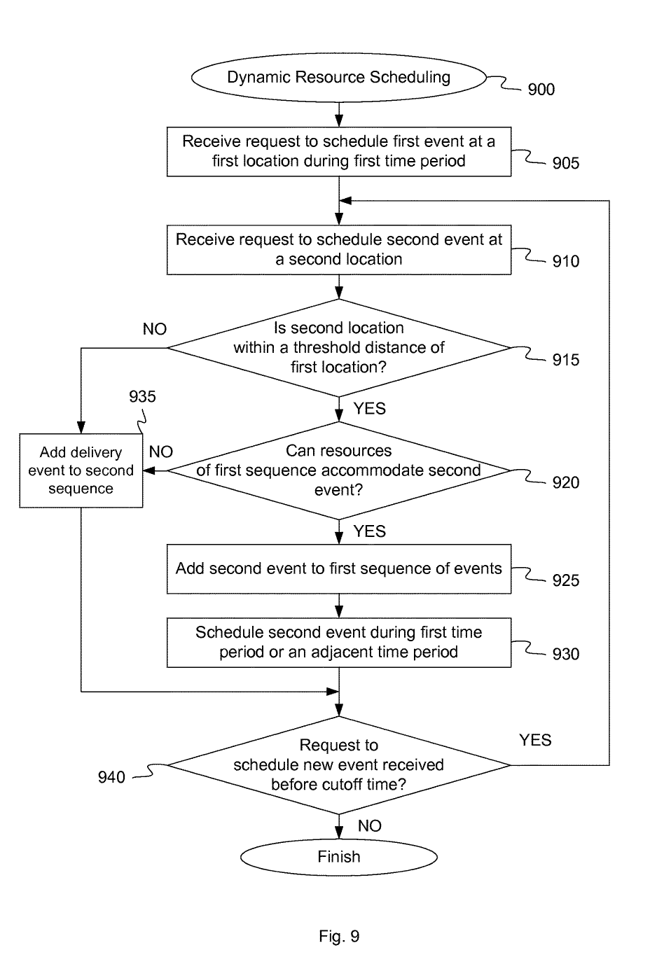

FIG. 9 is a flow diagram illustrating a dynamic resource scheduling method, according to an embodiment. The method 900 may be performed by processing logic that comprises hardware (e.g., circuitry, dedicated logic, programmable logic, microcode, etc.), software (e.g., instructions run on a processor to perform hardware simulation), firmware, or a combination thereof. The processing logic is configured to dynamically allocate and schedule resources in order to optimize a sequence of scheduled events. In one embodiment, method 900 may be performed by dynamic resource scheduler, as shown in FIGS. 2 and 3.

Referring to FIG. 9, at block 905, method 900 receives a first request to schedule a first event at a first location during a first time period. In one embodiment, client device interface module 311 receives information sent from web browsers 232, 242, 252, such as a request to schedule an event at a specified location. For example, client device interface module 311 may receive a request for delivery or pick-up of a package at a certain address. The request may also include a request time period during which the first event is to occur.

At block 910, method 900 receives a second request to schedule a second event at a second location. In one embodiment, client device interface module 311 receives a request for delivery or pick-up of a package at different address than the first address.

At block 915, method 900 determines whether the second location is within a threshold distance of the first location. In one embodiment, location proximity module 312 compares a distance between the second location and the first location to the threshold distance.

If the second location is within the threshold distance of the first location, at block 920, method 900 determines whether a resource associated with a first sequence of a plurality of events can accommodate the second event. In one embodiment, resource manager module 313 may verify that the delivery vehicle is able to accommodate an additional delivery during the requested or available time periods.

If the resource can accommodate the second event, at block 925, method 900 schedules the second event as part of the first sequence of events. At block 930, method 900 schedules the second event during at least one of the first time period and a second time period adjacent to the first time period. If the second location is not within the threshold distance of the first location or the resource cannot accommodate the second event, at block 935, method 900 schedules the second event as part of a second sequence of events, wherein the second sequence of events does not include the first event.

At block 940, method 900 determines whether a request to schedule a new event is received before a cut-off time. If a request to schedule a new event is received, method 900 returns to block 910 and performs the operations at block 910-935 for each new event.

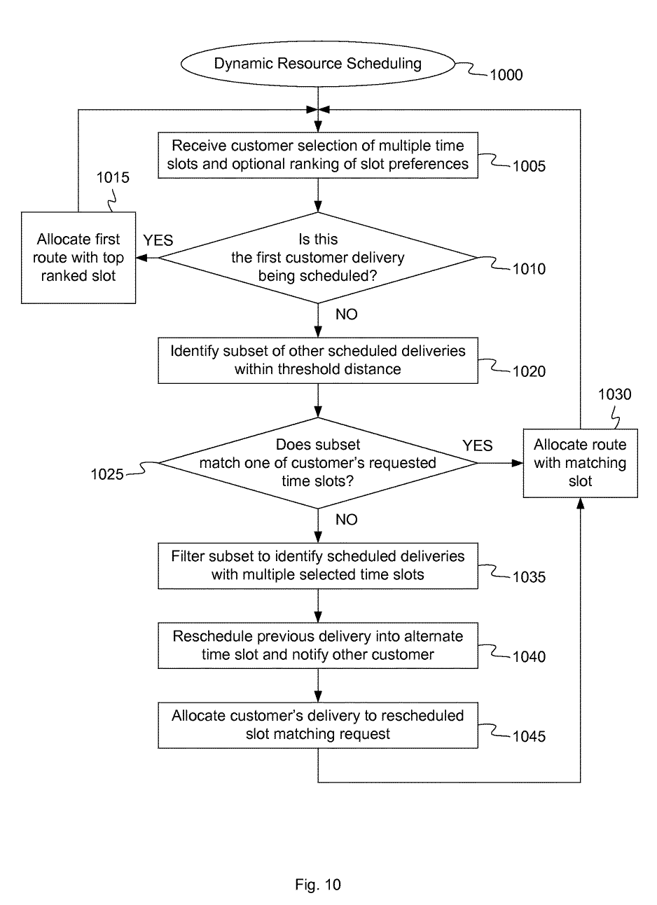

FIG. 10 is a flow diagram illustrating a dynamic resource scheduling method, according to an embodiment. The method 1000 may be performed by processing logic that comprises hardware (e.g., circuitry, dedicated logic, programmable logic, microcode, etc.), software (e.g., instructions run on a processor to perform hardware simulation), firmware, or a combination thereof. The processing logic is configured to dynamically allocate and schedule resources in order to optimize a sequence of scheduled events. In one embodiment, method 1000 may be performed by dynamic resource scheduler, as shown in FIGS. 2 and 3.

At block 1005, method 1000 receives a first request to schedule a first event at a first location. In one embodiment, client device interface module 311 receives information sent from web browsers 232, 242, 252, such as a request to schedule an event. For example, client device interface module 311 may receive a request for delivery or pick-up of a package at a certain address. In one embodiment, client device interface module 311 may receive a customer selection of multiple time slots or delivery time periods. These time slots may be alternative times when the customer is willing or able to have the package delivered. In one embodiment, there may optionally be a ranking of the time slots by preference, including, for example, a first choice, second choice, third choice, etc. In one embodiment, client interface module 311 records information about the request in order history data 322, including the number of selected time slots and any ranking information, if provided. The ranking information may correspond to a weighting value associated with each selected slot. If a particular slot is designated as the customer's first choice, then it may be assigned a higher weighting value, such that when attempting to match the slot with availability of resources on a given route, the first choice will be given greater priority.

At block 1010, method 1000 determines whether the current event is the first customer delivery being scheduled for a given day. In one embodiment, sequence planning module 315 consults order history data 322 to determine whether any deliveries or other events have been previously scheduled for a certain day. If there are no other deliveries identified in order history data 322, sequence planning module 315 determines that the current event is the first customer delivery being scheduled for the current day. In one embodiment, at block 1015, method 1000 allocates a first route with the customer's delivery scheduled for their top ranked time slot. In one embodiment, sequence planning module 315 creates a new route, schedules the delivery in the top ranked time slot and stores data pertaining to the route in sequence planning data 324. For example, an entry in sequence planning data 324 may include an indication of the address associated with the customer delivery and the scheduled time period, slot or window.

If the current request is not the first customer delivery being scheduled for the day (i.e., if there are previously scheduled events in order history data 322), at block 1020, method 1000 identifies a subset of other scheduled deliveries that fall within a threshold distance of the location of the current delivery being scheduled. In one embodiment, location proximity module 312 compares a distance between each location and the current location to a threshold distance, measured using at least one of a Euclidian distance, network distance or a number of event sectors between the two locations.

At block 1025, method 1000 determines whether any of the current customer's requested time slots match any of the scheduled deliveries from the subset identified at block 1020. In one embodiment, time period module 314 compares the time periods for which the previous deliveries are scheduled to the customer's currently selected time periods to see if there is any overlap. Overlap may include the same time period or one or more adjacent time periods. If time period module 314 identifies matching time periods, sequence planning module 315 may allocate route with the customer's delivery scheduled for the matching time slot.

If at block 1025, the time period module 314 does not identify any matching time periods from the subset of events, at block 1035, method 1000 further filters the subset to identify scheduled deliveries with multiple selected time slots. In one embodiment, time period module 314 consults order history data 322 where indications of multiple selected time slots are stored. At block 1040, method 1000 identifies one of the previous deliveries scheduled during a time slot that matches at least one of the current customer's selected delivery slots, and that has one or more alternative selected time slots. In one embodiment, sequence planning module 315 reschedules the identified event by removing the delivery from the previously scheduled time slot and, at block 1045, scheduling the current delivery in that time slot instead. In one embodiment, client device interface module 311 notifies the previous customer that the delivery has been rescheduled. Method 1000 proceeds to block 1030 where the route is allocated with the current delivery in the rescheduled time slot, and continues back to block 1005 to wait for another delivery request to be received.

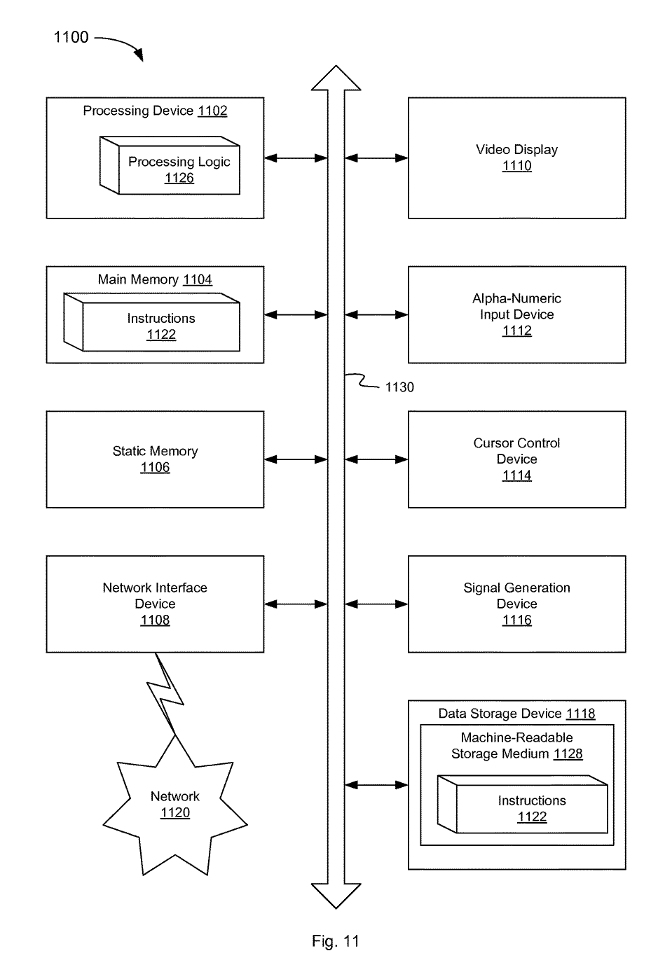

FIG. 11 illustrates a diagrammatic representation of a machine in the exemplary form of a computer system 1100 within which a set of instructions, for causing the machine to perform any one or more of the methodologies discussed herein, may be executed. The system 1100 may be in the form of a computer system within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 1100 may represent computing environment 201 of FIG. 2.

The exemplary computer system 1100 includes a processing device (processor) 1102, a main memory 1104 (e.g., read-only memory (ROM), flash memory, dynamic random access memory (DRAM) such as synchronous DRAM (SDRAM)), a static memory 1106 (e.g., flash memory, static random access memory (SRAM)), and a data storage device 1118, which communicate with each other via a bus 1130.

Processing device 1102 represents one or more general-purpose processing devices such as a microprocessor, central processing unit, or the like. More particularly, the processing device 1102 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1102 may also be one or more special-purpose processing devices such as an application specific integrated circuit (ASIC), a field programmable gate array (FPGA), a digital signal processor (DSP), network processor, or the like. The processing device 1102 is configured to execute the processing logic 1126 for performing the operations and steps discussed herein.

The computer system 1100 may further include a network interface device 1108. The computer system 1100 also may include a video display unit 1110 (e.g., a liquid crystal display (LCD) or a cathode ray tube (CRT)), an alphanumeric input device 1112 (e.g., a keyboard), a cursor control device 1114 (e.g., a mouse), and a signal generation device 1116 (e.g., a speaker).

The data storage device 1118 may include a computer-readable medium 1128 on which is stored one or more sets of instructions 1122 (e.g., instructions of dynamic resource scheduler 210) embodying any one or more of the methodologies or functions described herein. The instructions 1122 may also reside, completely or at least partially, within the main memory 1104 and/or within processing logic 1126 of the processing device 1102 during execution thereof by the computer system 1100, the main memory 1104 and the processing device 1102 also constituting computer-readable media. The instructions may further be transmitted or received over a network 1120 via the network interface device 1108.

While the computer-readable storage medium 1128 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media, and magnetic media.

The preceding description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the scope of the present invention.

In the above description, numerous details are set forth. It will be apparent, however, to one of ordinary skill in the art having the benefit of this disclosure, that embodiments of the invention may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining”, “identifying”, “adding”, “selecting” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the invention also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method comprising:
receiving, by a processing device, a first request for delivery of a first package to a first location;
providing, by the processing device, a first plurality of selectable time period options for the delivery of the first package;
receiving, by the processing device, a selection of a first delivery time period of the first plurality of selectable time period options;
adding, by the processing device, a first delivery event corresponding to the first request for delivery to a first route of planned deliveries on a first day;
receiving, by the processing device, a second request for delivery of a second package to a second location;
comparing, by the processing device, a distance between the second location and the first location to a threshold distance;
determining, by the processing device, that the second location is within the threshold distance of the first location;
providing, by the processing device, a second plurality of selectable time period options for the delivery of the second package, wherein the second plurality of selectable time period options comprises at least one of the first delivery time period or a second delivery time period adjacent to the first delivery time period;
receiving, by the processing device, a selection of one or more of the second plurality of selectable time period options; and
adding, by the processing device, a second delivery event corresponding to the second request for delivery to the first route.

2. The method of claim 1, further comprising:
receiving, by the processing device, a third request for delivery of a third package to a third location;
comparing, by the processing device, the third location to the first and second locations;
determining, by the processing device, that the third location is not within the threshold distance of either the first location or the second location; and
adding, by the processing device, a third delivery event corresponding to the third request for delivery to a second route of planned deliveries on the first day.

3. The method of claim 1, further comprising:
receiving, by the processing device, a selection of two or more of the second plurality of selectable time period options; and
assigning a weighting value to each of the two or more time period options, the respective weighting value indicative of a preference of time period options.

4. The method of claim 3, further comprising:
adding, by the processing device, the second delivery event corresponding to the second request for delivery to the first route at a time period based at least in part on the respective weighting value of each of the two or more time period options.

5. A system comprising:
a memory configured to store a dynamic resource scheduler; and
a processing device operatively coupled to the memory, the processing device to execute the dynamic resource scheduler from the memory, wherein the dynamic resource scheduler is configured to:
receive a first request to schedule a first event at a first location during a first time period;
receive a second request to schedule a second event at a second location;
determine that the second location is within a threshold distance of the first location;
present a first plurality of selectable time period options for scheduling the second event, wherein the first plurality of selectable time period options comprises at least one of the first time period and a second time period adjacent to the first time period;
receive a selection of at least one of the first plurality of selectable time period options; and
schedule the second event based at least in part on the selection.

6. The system of claim 5, wherein the dynamic resource scheduler is further configured to:
receive a selection of two or more of the first plurality of selectable time period options, the two or more options comprising alternative time period options for scheduling the second event.

7. The system of claim 5, wherein the dynamic resource scheduler is further configured to:
generate a first sequence of a plurality of events, comprising the first event and the second event, based on relative locations associated with the plurality of events; and
dynamically update the first sequence of the plurality of events when a request to schedule an additional event is received.

8. The system of claim 7, wherein the dynamic resource scheduler is further configured to:
determine that a resource associated with the first sequence of the plurality of events can accommodate the additional event; and
schedule the additional event as part of the first sequence of events.

9. The system of claim 7, wherein the dynamic resource scheduler is further configured to:
determine that a resource associated with the first sequence of the plurality of events cannot accommodate the additional event; and
schedule the additional event as part of a second sequence of events, wherein the second sequence of events does not include either the first event or the second event.

10. The system of claim 5, wherein the dynamic resource scheduler is further configured to:
receive a third request to schedule a third event at a third location;
determine that the third location is not within a threshold distance of either the first location or the second location;
schedule the third event as part of a second sequence of events, wherein the second sequence of events does not include either the first event or the second event.

11. The system of claim 10, wherein the dynamic resource scheduler is further configured to:
present a second plurality of selectable time period options for scheduling the third event, wherein the second plurality of selectable time period options is not based on time periods associated with the first event or the second event.

12. The system of claim 5, wherein the threshold distance is measured using at least one of a network distance or a number of event sectors between two locations.

13. The system of claim 5, wherein first event and the second event each comprise at least one of a pick-up or a delivery of a package.

14. A method comprising:
receiving, by a processing device, a first request to schedule a first event at a first location;
providing, by the processing device, a first plurality of selectable time period options for scheduling the first event based at least in part on a first sequence of events;
receiving, by the processing device, alternative selections of a first time period and a second time period for scheduling the first event from the first plurality of selectable time period options;
determining, by the processing device, whether a resource associated with the first sequence of events can accommodate the first event during the first time period;
upon determining that the resource associated with the first sequence of events can accommodate the first event during the first time period, scheduling, by the processing device, the first event during the first time period for the first sequence of events.

15. The method of claim 14, further comprising:
upon determining that the resource associated with the first sequence of events cannot accommodate the first event during the first time period, scheduling, by the processing device, the first event during the second time period for the first sequence of events.

16. The method of claim 14, further comprising:
determining at least one of the first sequence of events or a second sequence of events for which to schedule the first event based on at least one of the first time period or the second time period.

17. The method of claim 14, further comprising:
receiving a second request to schedule a second event at a second location;
providing a second plurality of selectable time period options for scheduling the second event; and
receiving alternative selections of a third time period and a fourth time period for scheduling the second event from the second plurality of selectable time period options.

18. The method of claim 17, further comprising:
determining that the second location is within a threshold distance of the first location; and
providing the first time period as one of the second plurality of selectable time period options.

19. The method of claim 17, further comprising:
determining whether the resource associated with the first sequence of events can accommodate the second event during at least one of the third time period or the fourth time period;
upon determining that the resource can accommodate the second event during at least one of the third time period or the fourth time period, scheduling the second event during the at least one of the third time period or the fourth time period for the first sequence of events.

20. The method of claim 19, further comprising:
upon determining that the resource cannot accommodate the second event during at least one of the third time period or the fourth time period, scheduling the second event during at least one of the third time period or the fourth time period for a second sequence of events.
